(19) United States
(12) Patent Application Publication
(10) Pub. No.: US 2007/0289272 A1
(43) Pub. Date: Dec. 20, 2007

(54) Nestable, rigid, planar air filter frame

(76) Inventor: Thomas A. Justice, (US)

Correspondence Address: NIXON PEABODY, LLP, 401 9TH STREET, NW, SUITE 900, WASHINGTON, DC, 20004-2128, US

(21) Appl. No.: 11/454,010

(22) Filed: Jun. 16, 2006

(51) Int. Cl. B01D 46/00

(52) U.S. Cl. 55/495

(57) ABSTRACT

A nestable frame for planar air filters or other screen-like planar structures. The nestable frame provides all of the following desirable properties at once: 1. Simple manufacturing and assembly process, 2. Simple design, 3. Enhanced structural rigidity, 4. Significant space-savings during storage and transport, and 5. Simple handling. Preferably, the filter frame comprises an upper and a lower frame portion with a first leg each, where the peripheral edge of the filter media is clampingly engaged between the first leg of the upper frame portion and the first leg of the lower frame portion. From the first leg, the upper frame portion extends outwardly with at least two legs folded into a vertically flipped V. The lower frame portion consists of at least two full and a third partial leg, and may or may not have additional legs extending outwardly, in parallel direction and intimately connected to the legs of the upper frame portion. There are no voids between any of the legs in the V-shaped region of the upper frame portion and the lower frame portion. Alternative embodiments may be of different cross-sectional shapes that widen the vertically flipped V cross-section, again with various numbers of legs in the upper and lower frame portions. Further included in the present invention are manufacturing methods for the stackable frame.

### BACKGROUND OF THE INVENTION

1. Field of the Invention

The present invention relates generally to air filters and, more particularly, to a nestable frame for planar air filters or other screen-like planar structures.

2. Description of the Prior Art

Filters are typically provided in heating, ventilating and air conditioning equipment upstream of the air handler for removing particulate impurities from the air principally in order to protect the equipment, and secondarily to remove particulate impurities from the air circulated within homes, offices and industrial environments that affect the indoor air quality to which people are exposed. Such filters are also used for removing impurities entrained in air or another gas prior to release of the gas into the atmosphere. Various industrial processes also use filters for removing particulates from gases or other fluids.

Filters are typically formed by mounting a panel of a filter medium, such as a fibrous mat or porous foam or a pleated panel of a filter medium to reduce the relative pressure drop, within a surrounding support frame. The frame supports the filter medium in a relatively planar shape and provides mechanical strength for retaining the filter in a manner which is not only mechanically secure but also seals well to its associated machinery so that all of the fluid flow is directed through the filter medium. It is desirable for a filter to be inexpensive and have sufficient strength and durability. It is also desirable to maximize the effective filtering area of a filter and to permit the compact packaging of multiple filters for efficient distribution and storage.

Generally, prior art in the field of air filters relates to three different types of devices:
a) filters with a box-like frame,
b) filters with a frame that is essentially incompressible, and
c) filters that consist of a frame that is compressible, collapsible or stackable, so that multiple filters can be stacked tightly during storage and transport prior to usage.

Relevant prior art to the present invention relates to type c) above.

A basic example of a stackable planar filter was disclosed in U.S. Pat. No. 3,970,440 issued Jul. 20, 1976, to Copenhefer, et al. for a Compact Air Filter. This planar air filter comprises a frame formed of an integral suitable cut and scored blank of paperboard, which, when assembled, comprises planar frame members engaging a substantially sheet-form filter element there between. Attached to the planar frame members, the disclosed frame has flared frame members disposed at an angle of less than 180 degree permitting a plurality of frames to nest within each other, thereby reducing the bulk of the plurality of filters. More sophisticated prior art subsequent to this patent is cited below with brief abstract statements summarizing the main points for each reference:

U.S. Pat. No. 4,068,071 issued Apr. 25, 1978, to Champlin for an Air filter assembly, describes an air filter that contains a multisided supporting frame. The frame includes a foraminous center section, a marginal section delimiting the center section, and flanges connected to the marginal section. The center and marginal sections are in supporting engagement with one surface of the filter panel. The flange segments are foldably connected to the marginal sections and extend angularly inwardly therefrom forming an acute angle with the corresponding marginal sections. The construction of the frame enables the filter assembly to assume a collapsed state so that a plurality of such assemblies can form a compact bundle for shipping and/or storage.

U.S. Pat. No. 4,105,423 issued Aug. 8, 1978, to Latakas, et al. for a Compact air filter with tubular frame, describes a compact nestable air filter comprising a frame formed of an integral suitable cut and scored blank of paperboard. The assembled frame comprises planar frame members engaging a sheet-form filter element there between, and has flared frame members disposed at an angle of less than 180 degree permitting a plurality of completed filters to nest within each other, thereby reducing the bulk of the plurality of filters. The flared frame members have a tubular contour, greatly increasing their strength and rigidity.

U.S. Pat. No. 4,372,763 issued Feb. 8, 1983, to Champlin, et al. for an Air filter assembly, describes an air filter assembly comprising a compressible air pervious multi-sided filter panel and a frame therefor. The frame is adjustable from a collapsed mode to an operative mode. The frame of foldable sheet material includes a foraminous center section in supporting engagement with the filter panel; a marginal section delimiting the center section; and a plurality of elongated peripheral sections foldably connected to the marginal sections. The peripheral and the marginal sections form a hollow verge encompassing the filter panel periphery when the frame is in the operating mode. The peripheral sections form a substantially flat multiply flange overlapping and compressing the filter panel periphery when the frame is collapsed. When the frame is adjusted from the collapsed mode to the operating mode, the overlapped end portions of the peripheral sections will abuttingly engage at an angle and restrain movement of the frame from the operating mode back to the collapsed mode.

U.S. Pat. No. 4,636,233 issued Jan. 13, 1987, to Lizmore for a Filter assembly, describes a filter assembly including a casing with a support panel to support the filter element and upstanding walls extending around the periphery of the casing. The walls are inclined to the support panel to permit nesting of the casings during transport.

U.S. Pat. No. 5,800,588 issued Sep. 1, 1998, to Miller for a Nestable, rigid filter frame describes a filter with a nestable frame. The frame includes a first leg, a second leg extending obtusely from the first leg, and a third leg extending from the second leg and forming a channel between the second and third legs. The filter also includes a brace with similar first, second and third legs. The brace is mounted to the frame, with its second and third legs extending into the channel of the frame. A chamber is formed by the second and third legs of the frame and the second and third legs of the brace. The chamber is preferably filled with material which rigidities the box beam structure formed by the walls surrounding the chamber. A filter medium material attaches to the frame, by adhesion and/or by clamping engagement between the first legs of the frame and brace.

U.S. Pat. No. 6,033,454 issued Mar. 7, 2000, to Hoeffken for an Air filter assembly, describes a filter frame with planar surfaces and rails along outer edges of the planar surfaces. The rails flare outwardly at an obtuse angle from the plane when the frame is unconfined One of the rails at each corner of the rectangular frame is provided with tabs, and the other rail at the corner has an open end into which the tab extends. The tabs are slidable to enable collapsing of the rails for transport but confined by their geometry to prevent disengagement of the rails when the frame is assembled.

None of the prior art provide a frame with all of the following desirable properties: 1) simple manufacturing and assembly process, 2) simple design, 3) enhanced structural rigidity, 4) significant space-savings during storage and transport, 5) simple handling, and 6) lower material handling and packaging costs. A combination of all these functionalities is desired, because all simplicity aspects and space savings result in cost-savings, and structural rigidity of the frame is required for quality purposes.

Filter frames in prior art that provide for sufficient frame stability contain a tubular profile or a void as element required for the enhanced rigidity. Such voids make the frame more complex and are difficult to manufacture.

Filter frames in prior art with only one frame leg extending from the planar filter media are simple in design but do not provide sufficient rigidity.

Filter frames that can be stacked tightly in a collapsed mode, and become rigid by unfolding them to the operating mode, require additional attention after packaging and transport, and therefor increase operating cost.

Thus, there remains a need for a stackable filter frame that is cost-efficient in manufacture and operation, and simple in design, can be compactly stacked during storage and transport, and yet exhibits structural rigidity to provide a high-quality product.

### SUMMARY OF THE INVENTION

The present invention is directed to a planar, nestable air filter with several variations in frame geometry capable of providing a simple, stable frame for planar air filter panels. The frame design described is cost-effective in manufacturing and operation, and allows for savings in storage and transportation cost, since the volume is reduced significantly when several air filters are packaged together. In addition, the frame geometry provides sufficient rigidity to result in a high-quality filter.

In a preferred embodiment, the filter frame comprises an upper and a lower frame portion with a first leg each, where the peripheral edge of the filter media is clamped, adhered, stapled, or with other suitable means engaged between the first leg of the upper frame portion and the first leg of the lower frame portion. From the first leg, the upper frame portion extends outwardly with at least two legs forming a vertically flipped V. The lower frame portion has at least a second leg and a third leg of partial or full length, extending outwardly from the first leg. The legs of the lower frame portion are in parallel direction and intimately connected by suitable means such as adhesion to the legs of the upper frame portion. The upper and lower frame portion may consist of two or eight separate materials, or they may be made from one single piece of material suitably folded back on itself and connected at the outside edge and of the third leg of each portion.

In an alternative embodiment, an additional leg is inserted between the legs of the flipped V. This leg may be horizontal and straight, or curved. In this embodiment, the upper frame portion consists of at least four legs, while the lower frame portion consists of a minimum of three legs.

The present invention is further directed to a method for manufacture and assembly of the stackable frame. The frame may for example be manufactured from one single blank, from one single blank per frame portion, from four single blanks for each frame side, from eight single blanks, or from a variable number of strips to form a variable number of frame sides at once. These and other aspects of the present invention will become apparent to those skilled in the art after a reading of the following description of a preferred embodiment when considered with the drawings.

### BRIEF DESCRIPTION OF THE DRAWINGS

FIG. 1 is a perspective illustration of a planar air filter comprising the nestable frame in a first preferred form of the invention.

FIG. 2 is a view in vertical section taken substantially along the line 2-2 of FIG. 1 illustrating a segment of the filter of FIG. 1.

FIG. 3 through 8 are views in section illustrating alternative filter frames embodying the present invention.

FIG. 9 through 13 are views in section illustrating yet alternative filter frames embodying the present invention.

FIG. 14 through 20 are views in section illustrating yet alternative filter frames embodying the present invention.

FIG. 21 through 30 are views in section illustrating yet alternative filter frames embodying the present invention.

FIG. 31 is a view in section similar to the section of FIG. 2, but illustrating a plurality of stacked filters in a package.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” “horizontal,” “vertical,” and the like are words of convenience and are not to be construed as limiting terms.

Referring now to the drawings in general, the illustrations are for the purpose of describing a preferred embodiment of the invention and are not intended to limit the invention thereto.

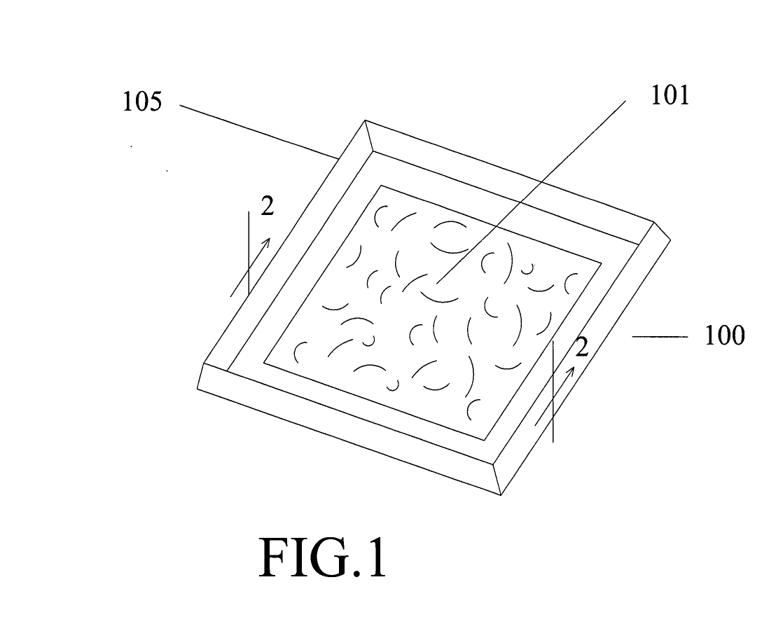

FIG. 1 shows a perspective illustration of the filter, generally referred to as 100. The filter 100 comprises a planar panel of filter medium, 101, which is delimited to all sides by the surrounding periphery 102. The surrounding periphery of the filter medium is held within the filter frame 105.

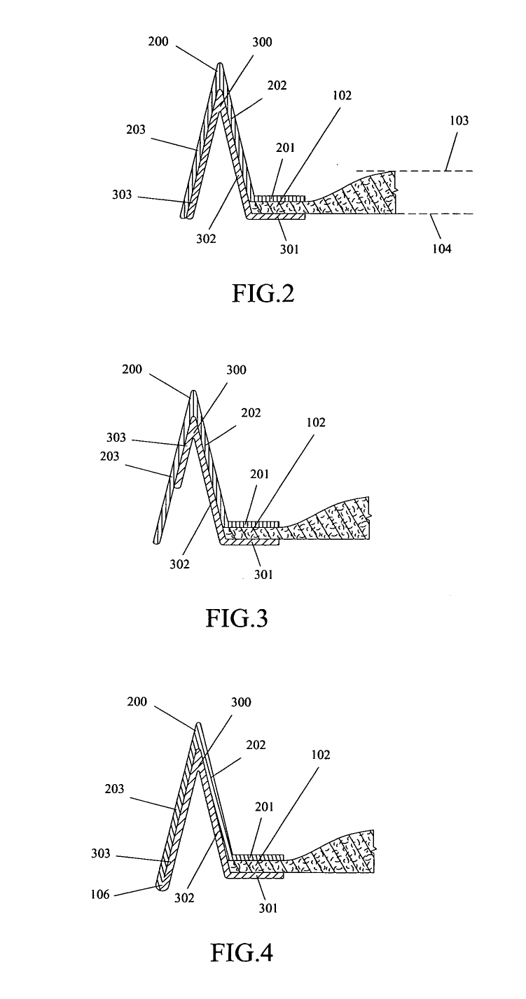

FIG. 2 shows a cross-sectional view of the filter in FIG. 1 along the line 2-2.

The filter panel 101 has a substantially uniform thickness with two opposing major faces, 103 and 104. The filter frame 105 consists of one upper frame portion 200 and one lower frame portion 300.

The first leg of the upper frame portion 201 and the first leg of the lower frame portion 301 form an overlapping sandwich composite with the surrounding periphery of the filter medium 102 in a clamp-like action. This clamp-like action is for example achieved by means of adhesion, friction or bonding, stapling, or other suitable engagement mechanism.

From the first leg 201, the upper frame portion 200 extends outwardly from the filter panel periphery 102 with a second and third leg 202 and 203. The second and third leg of the upper frame portion 202 and 203 are angled to each other at less than 90 degrees, essentially forming a V-shape (flipped vertically with respect to the page). This cross-sectional frame shape allows the nesting of multiple frames and therefore filters in vertical direction. The second and third leg of the lower frame portion, 302 and 303, extend outwardly from the filter medium periphery 102 as well and form the same angle to each other as the corresponding legs of the upper frame portion, 202 and 203.

The second and third legs of the upper frame portion, 202 and 203 are intimately connected with the corresponding legs of the lower frame portion, 302 and 303, to avoid any voids between them, for example by means of adhesion, friction or bonding. The lack of any significant void between the V-shaped region of the upper and lower frame portions provided for a high nesting efficiency while maintaining sufficient frame rigidity.

The upper and the lower frame portions 200 and 300 may be of a different material, different material strength, stiffness or thickness. Specifically, the upper frame portion 200 may be of significantly thicker and stiffer material than the lower frame portion 300.

FIG. 3 shows a design variation of the filter frame 105. In this embodiment, the shape is essentially the same as in FIG. 2, but the third leg of the lower frame portion 303 is only a partial leg and shorter than the third leg of the upper frame portion 203.

FIG. 4 shows another design variation. In this embodiment, the shape is essentially the same as in FIG. 2, but the upper frame portion 200 and the lower frame portion 300 are made out of one single blank of material that is folded 360 degree back onto itself at an outward backfold of the filter frame, 106.

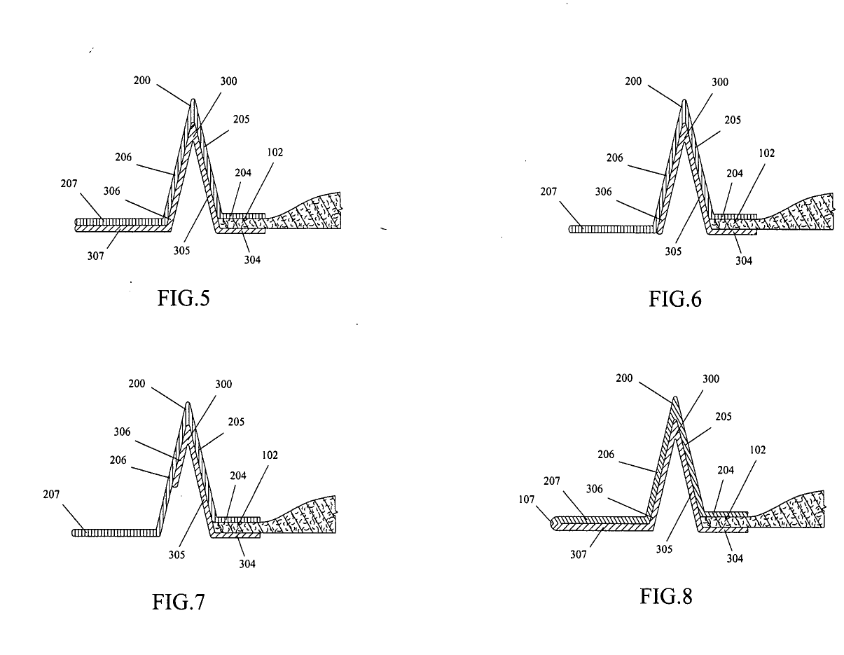

FIG. 5 shows yet another design variation of the filter frame 105. In this embodiment, the shape of the frame 105 is essentially the same as in FIG. 2, except that both frame portions are extended by a fourth leg each, 207 and 307. This construction may be used to further increase the rigidity and strength of the frame. The embodiment may also include a design where only one of the frame portions is extended by a fourth leg, either 207 or 307, as exemplary shown in FIG. 6. This construction may also include an upper frame portion 200 with a total of four legs, while the lower frame portion 300 consists of two legs and a partial third leg, or three legs and a partial fourth leg, as exemplary shown in FIG. 7. FIG. 8 shows a design variation where the upper and lower frame portions are made out of one material blank that is folded back onto itself at the outward backfold of the filter frame.

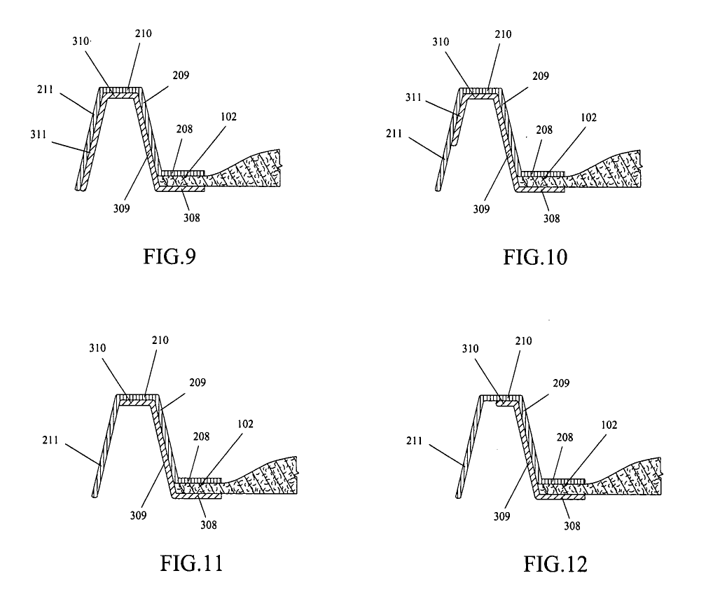

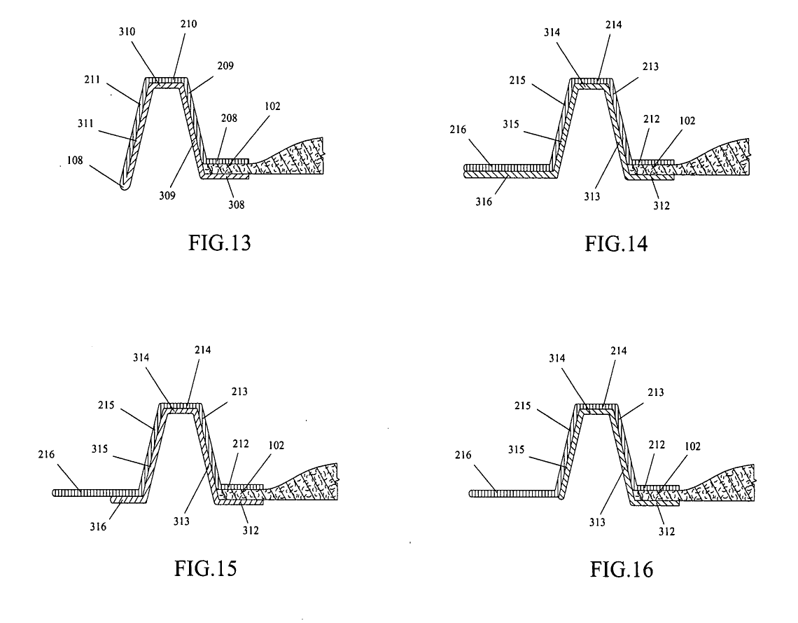

FIG. 9 shows yet another design variation of the filter frame 105. In this embodiment, the V-shape of the frame 105 in FIG. 2 is altered by inserting additional horizontal frame legs 210 and 310. The horizontal frame legs 208 and 308 are holding the periphery of the filter material, the legs 209 and 309 are diagonally leaning away from the filter panel plane, the connecting third legs 210 and 310 are horizontal, and the fourth legs 211 and 311 are diagonally leaning away from the filter panel. FIG. 10 shows a design variation where the fourth leg of the lower frame portion 311 is only a partial leg, FIG. 11 shows a design without a fourth leg in the lower frame portion, and FIG. 12 shows a design where the third leg of the lower frame 310 portion is a partial leg. FIG. 13 shows a design where the upper and lower frame portions 200 and 300 are made out of one single blank of material that is folded back onto itself at the outward backfold of the filter frame.

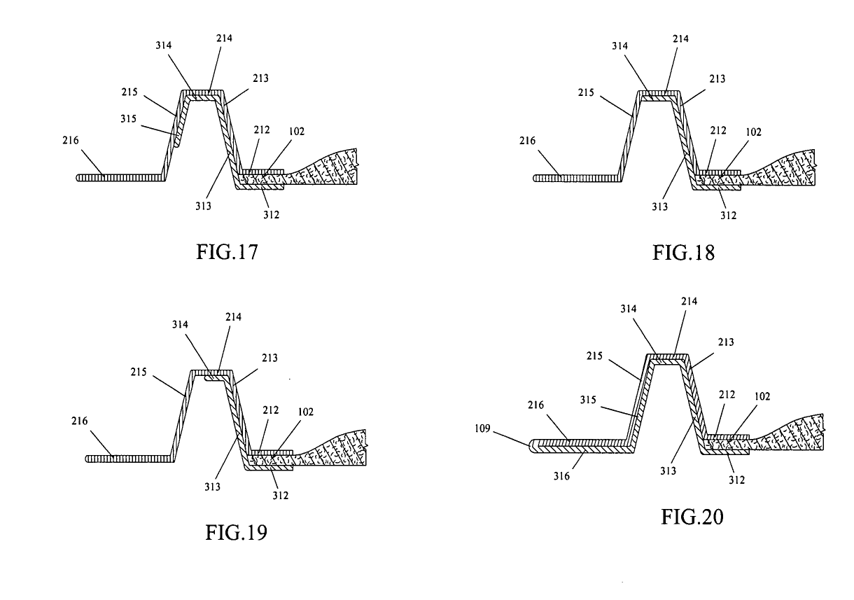

FIG. 14 shows yet another design variation of the filter frame 105. In this embodiment, the V-shape of the frame 105 in FIG. 2 is altered by inserting additional horizontal frame legs 214 and 314. The horizontal frame legs 212 and 312 are holding the periphery of the filter material, the legs 213 and 313 are diagonally leaning away from the filter panel plane, the connecting third legs 214 and 314 are horizontal, the fourth legs 215 and 315 are diagonally leaning away from the filter panel, and the fifth legs 216 and 316 are added horizontally for increased rigidity. FIG. 15 shows a design variation where the fifth leg of the lower frame portion 316 is only a partial leg. FIG. 16 shows a design without a fifth leg in the lower frame portion. FIG. 17 shows a design where the fourth leg of the lower frame 315 portion is a partial leg. FIG. 18 shows a design where the lower frame portion only consists of the first, second and third legs 312, 313, and 314. FIG. 19 shows a design where the lower frame portion consists of legs 312, 313, and a partial third leg 314. Finally, FIG. 20 shows a design where the upper and lower frame portions 200 and 300 are made out of one single blank of material that is folded back onto itself at the outward backfold of the filter frame.

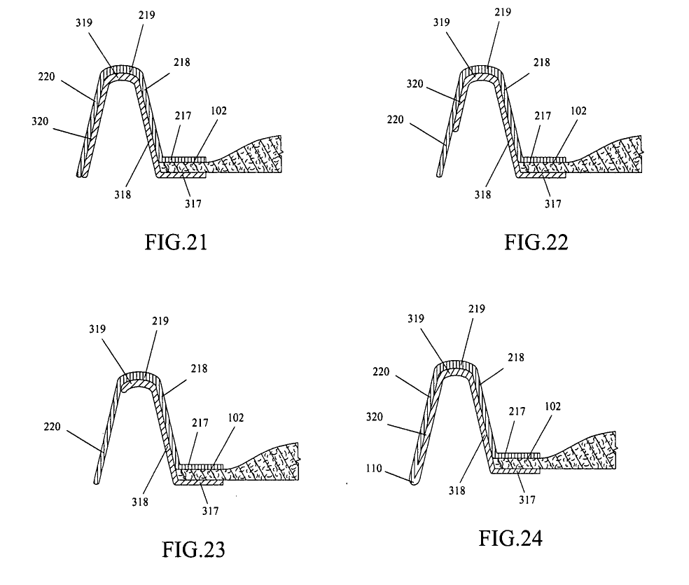

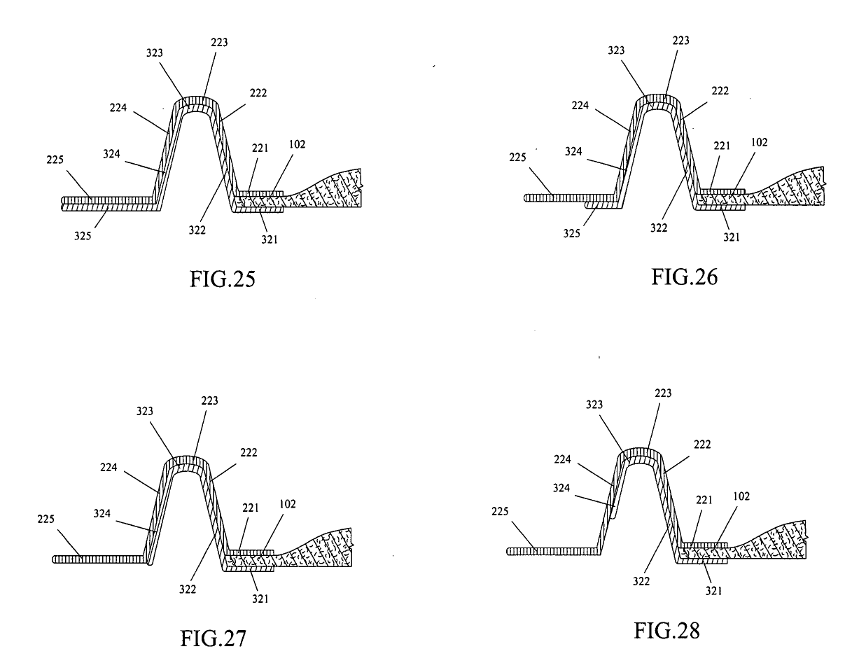

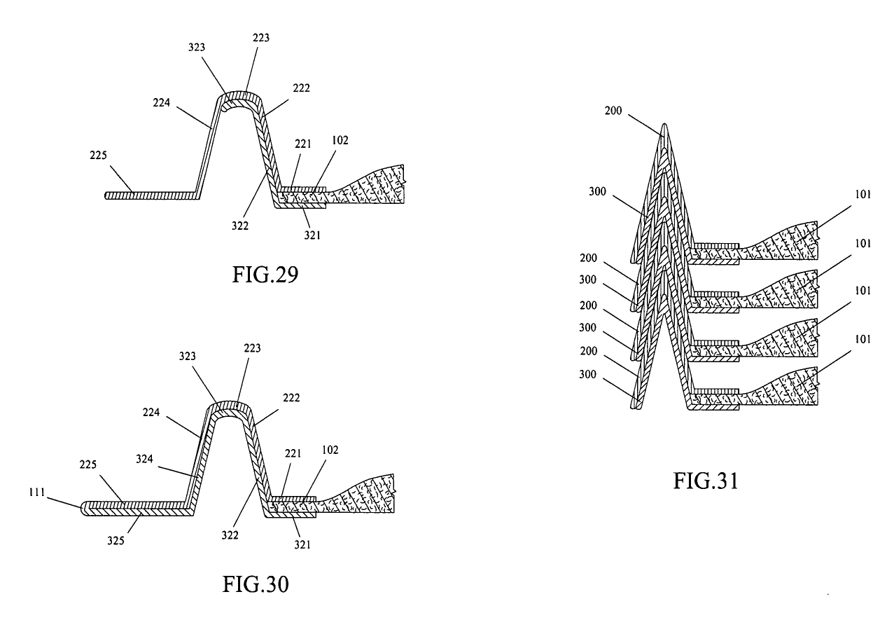

FIG. 21 shows yet another design variation of the filter frame 105. In this embodiment, the V-shape of the frame 105 in FIG. 2 is altered by inserting additional curved frame legs 219 and 319. As with the design in FIG. 2, the first leg of the upper frame portion 217 and the first leg of the lower frame portion 317 form an overlapping sandwich composite with the surrounding periphery of the filter medium 102 in a clamp-like action. The geometric dimensions of the frame portions 200 and 300 to each other are such that all further legs of the upper frame portion 200 extending outwardly from the filter panel periphery 102 are intimately adhered to their corresponding legs of the lower frame portion 300, without allowing any voids between them. In FIG. 21 through FIG. 30, the first legs of upper and lower frame portion are denoted as 217 and 317, the second legs are denoted as 218 and 318, the third, curved legs are denoted as 219 and 319, and the fourth legs are denoted as 220 and 320. As shown in FIG. 22, the fourth leg of the lower frame portion 320 may be a partial leg, or as in FIG. 23, completely missing. As shown in FIG. 24, the two frame portions may be made out of one single, backfolded blank of material.

FIG. 26 through 30 show design variations of FIG. 21 through 24, with a fifth horizontal leg in the upper frame portion 225. Again, fourth and fifth legs of the lower frame portion 323 and 324 may be missing or partial. FIG. 30 shows the design from one single blank of material.

FIG. 31 shows by example of the frame design of FIG. 2, how multiple filters can be stacked normal to the filter panel plane, further referred to as vertically, and nested in such a way that they take significantly less space vertically than the same number of filters would take if they were not nested, but stacked on top of each other.

Certain modifications and improvements will occur to those skilled in the art upon a reading of the foregoing description. All modifications and improvements have been deleted herein for the sake of conciseness and readability but are properly within the scope of the following claims.

1. A filter comprising:
a. a filter medium having at least one peripheral edge; and
b. a frame member surrounding the at least one peripheral edge of the filter medium panel, the frame member having a cross-section comprising:
i. an upper frame portion and a lower frame portion;
ii. wherein the upper frame portion comprises a first leg, a second leg extending at an obtuse angle from the first leg, and a third leg extending at an angle from the second leg such that the second and third legs form a V-shape;
iii. wherein the lower frame portion comprises a first leg, a second leg extending at an obtuse angle from the first leg, and a third leg extending at an angle from the second leg;
iv. wherein the first leg of the lower frame portion is substantially parallel to the first leg of the upper frame and the second and third legs of the lower frame portion abut the second and third legs of the upper frame portion such that there is no significant void between the second and third legs of the upper frame portion and the second and third legs of the lower frame portion.
v. wherein the first leg of the upper frame portion and the first leg of the lower frame portion engage the at least one peripheral edge of the filter medium.

2. The filter of claim 1, wherein the second and third legs of the lower frame portion abut substantially all of the upper frame portion's second and third legs.

3. The filter of claim 1, wherein the upper frame portion and the lower frame portion are made from one piece of material.

4. The filter of claim 1, wherein the first legs of the upper and lower frame portions engage the at least one peripheral edge of the filter medium with an engagement means selected from the group consisting of an adhesive, at least one staple, a clamping force, and a friction force.

5. The filter of claim 1, wherein the upper frame portion further comprises a fourth leg extending from the third leg of the upper frame portion.

6. The filter of claim 5, wherein the lower frame portion further comprises a fourth leg extending from the third leg of the lower frame portion.

7. The filter of claim 6, wherein the upper frame portion and the lower frame portion are made from one piece of material.

8. The filter of claim 1, wherein the lower frame portion further comprises a fourth leg extending from the third leg of the lower frame portion.

9. A filter comprising:
a. a filter medium having at least one peripheral edge; and
b. a frame member surrounding the at least one peripheral edge of the filter medium panel, the frame member having a cross-section comprising:
i. an upper frame portion;
ii. wherein the upper frame portion comprises a first leg, a second leg extending at an obtuse angle from the first leg, a spacing leg extending from the second leg, and a third leg extending from the spacing leg and oriented at an angle to the second leg such that the second, third, and spacing legs permit nesting;
iii. wherein the lower frame portion comprises a first leg, a second leg extending at an obtuse angle from the first leg, a spacing leg extending from the second leg, and a third leg extending from the spacing leg and oriented at an angle to the second leg such that the second, third, and spacing legs permit nesting;
iv. wherein the first leg of the lower frame portion is substantially parallel to the first leg of the upper frame and the second, third, and spacing legs of the lower frame portion abut the second, third, and spacing legs of the upper frame portion such that there is no significant void between the second, third, and spacing legs of the upper frame portion and the second, third, and spacing legs of the lower frame portion;
v. wherein the first leg of the upper frame portion and the first leg of the lower frame portion engage the at least one peripheral edge of the filter medium.

10. The filter of frame 9, wherein the spacing legs are substantially straight.

11. The filter of frame 9, wherein the spacing legs are curved.

12. The filter of frame 9, wherein the second, third, and spacking legs of the lower frame portion abut substantially all of the upper frame portion's second, third, and spacing legs.

13. The filter of frame 9, wherein the upper frame portion and the lower frame portion are made from one piece of material.

14. The filter of frame 9, wherein the first legs of the upper and lower frame portions engage the at least one peripheral edge of the filter medium with an engagement means selected from the group consisting of an adhesive, at least one staple, a clamping force, and a friction force.

15. The filter of frame 9, wherein the upper frame portion further comprises a fourth leg extending from the third leg of the upper frame portion.

16. The filter of claim 15, wherein the lower frame portion further comprises a fourth leg extending from the third leg of the lower frame portion.

17. The filter of claim 16, wherein the upper frame portion and the lower frame portion are made from one piece of material.

18. The filter of frame 9, wherein the lower frame portion further comprises a fourth leg extending from the third leg of the lower frame portion.
